(19) United States
(12) Patent Application Publication
(10) Pub. No.: US 2009/0305006 A1
(43) Pub. Date: Dec. 10, 2009

(54) Printed product and method for the production thereof

(75) Inventor: Guido Steffen, Meilen (CH)

Correspondence Address: PAULEY PETERSEN & ERICKSON, 2800 WEST HIGGINS ROAD, SUITE 365, HOFFMAN ESTATES, IL, 60169, US

(73) Assignee: Ferag AG, Hinwil (CH)

(21) Appl. No.: 12/311,269

(22) PCT Filed: Aug. 2, 2007
(86) PCT No.: PCT/CH2007/000378

§ 371 Date: Aug. 17, 2009

(30) Foreign Application Priority Data
Sep. 21, 2006 (CH) 1508/06

(51) Int. Cl. B32B 3/02; G06F 3/12

(52) U.S. Cl. 428/195.1; 358/1.1

(57) ABSTRACT

The invention proposes a new printed product and a new production method and a new system for producing printed products which exploit weblogs and the blog articles contained therein as a source of news for conventional printed media. A decisive difference from known electronic products and corresponding methods in which blog articles or postings are made available online is that, according to the present invention, the blog articles are fed into the prepress stage in a novel manner and are processed there in order to be supplied to printing forme production following layout creation which is preferably automated depending on the printing method. The methods and systems according to the invention allow the blog articles or postings to be checked, categorized and assessed in such a manner that the actual amount of editing can be considerably reduced in the prepress area. This results in massive savings since a relevant editor is advantageously provided with a preferably precategorized preselection of blog articles, ideally in the form of ranking lists, by means of assessment methods and systems, which are described in more detail below, and optionally upstream checking methods and systems. The new method preferably uses postings by bloggers who have agreed to commercial use of their blog articles for publication in the printed product according to the invention and possible subsequent uses as part of an online registration and certification process via a blog portal. The legal certainty for the commercial operator of the blog portal and the producer of the new printed product is thus increased tremendously.

### FIELD OF THE INVENTION

The present invention relates to a printed product according to the precharacterizing clause of Patent claim 14, to a method for producing a printed product according to the precharacterizing clause of Patent claim 1, and to a system for producing a printed product according to the precharacterizing clause of Patent claim 13.

### BACKGROUND OF THE INVENTION

The term weblog which is composed of the words web and log was coined in 1997 by the American John Borgar who published a regularly updated online diary, also referred to as a blog for short, on the Internet. He is therefore often called the first blogger and the inventor of the weblog.

The number of weblogs has increased phenomenally in recent years. At the moment, there might be approximately more than 70 million blogs worldwide. Bloggers have also been using video and mobile radio technology for a long time, with the result that so-called vilogs (video blogs) and moblogs (mobile blogs) can also be found on the Internet in addition to the conventional weblog.

In addition to the original Internet diaries which are devoted to the author's feelings, blogs on any conceivable topic from politics, cars, sports, music, literature, technology to patent law have been found in the meantime. The transitions between the types of blogs are seamless but it can be determined that weblogs which tend to be personal are written by private individuals and specialized weblogs are written in a team, often also in combination with a company.

A current development which can be observed in many weblogs is that the person reading the blog is given the opportunity to give his personal opinion on an entry. The weblog thus becomes an interactive platform on the Internet on which a weblog operator or blogger expresses his opinion on a problem and at the same time makes it possible for the reader to also express his opinion and thus become the blogger. However, the readers' comments often do not appear on the front page of the weblog but rather on hierarchically lower pages and are connected to the primary entry by means of links or threads.

The importance of weblogs as a source of information and not least also as an instrument for forming opinion is still often underestimated in Europe and is also not taken seriously, especially by the established media of press, radio and television. In contrast, in the USA, for example during the 2004 presidential campaign, bloggers from the Democratic Party were officially invited to the National Convention and were treated as regular correspondents.

The publishers, as traditionally the most important information providers, recognized, after the initial euphoria on the subject of the electronic newspaper had died down, that it was not enough to make the existing print range available as an “electronic newspaper” on the Internet in more or less unchanged form. As early as 1997, R. Specker described, in “Chancen und Risiken einer individuellen Informationsvermittlung” [Opportunities and risks of individual communication of information], that the presentation of news on a screen requires different logic and aesthetics from those in a printed product and that the reader of an electronic newspaper himself decides what he wishes to see and what he does not wish to see to a much greater degree than in a printed product. Since electronic newspapers do not have any space restrictions in principle, any news may be theoretically given in any desired detail and may be linked to additional background information. This may be hypertext links to other relevant information on the Internet such as encyclopaedia articles, photographs, diagrams, notes or audio clips or even video sequences. It was also recognized that the interactive nature of the Internet opens up new possibilities for providing added value in comparison with conventional printed products. Feedback via email, which is possible with the least amount of effort, for example to the authors of a particular article, increases reader loyalty, on the one hand, and, on the other hand, provides communicators who traditionally receive little feedback with a welcome input for their work which goes beyond the known market research studies both qualitatively and quantitatively.

Although the problem of self-competition arises for publishers which primarily also present an already existing printed product, for example a daily or weekly newspaper, online, a considerable advantage of electronic online news over printed products is still that an electronic news product can be produced with relatively little initial investment and with low ongoing costs. However, the possible savings are actually restricted primarily, if not exclusively, to the printing process and the subsequent distribution of the printed products since the selection of news and the editorial work before the prepress area are effected in relatively unchanged fashion and no cost reductions are thus achieved in these areas.

Different publishers are currently trying to copy the concepts of successful weblogs to their online portals, or successful bloggers, that is to say bloggers with a large number of hits or a high ranking, are contracted as columnists. In this case, the blog is understood as meaning only a supplement to the traditional news provided and does not play an important role when the editorial staff is acquiring information, or when designing and producing the conventional printed product.

It is still underestimated that many weblogs act as actual search and filter engines in the network and are a preselection of particular subject areas from the vast range of information in the world wide web. There is likewise often a failure to recognize that the opinion leadership on particular subjects on the Internet clearly lies with particular blogs and not with the portals or pages of commercial, institutional or state providers and/or operators. So-called knowledge blogs or K-logs (where K-log stands for “knowledge log”) have also recently become established as a resource for expert knowledge.

If entries from a weblog are intended to be published in an online newspaper, it is not only necessary to currently verify the authenticity of these entries but problems of copyright also generally arise. In order to be able to legally qualify a weblog, a distinction must be made between the articles written by the weblog owner and those which comment on said articles. The articles written by the weblog owner and those written by the readers may be very different. For example, summaries of media contents with an associated hyperlink are presented, or else personal poems and text. On the basis of this variety, the type and content of each individual article (also referred to as a posting) must be investigated in order to be able to assign the character of a work to the respective posting or deny such a character.

Works are intellectual creations in literature and art which have an individual character. A work must be an intellectual creation and must thus arise from an intellectual activity of a human being. Without a doubt, all postings can be defined as intellectual creations but they are of a human nature. The individual character is a further prerequisite for protecting a work by copyright. For example, intellectual creations which are made by any desired human being in the same manner do not have an individual character but exceptions in the individual case are also conceivable here. The quality of the postings is so different that only the individual case can currently be used to assess whether there is an intellectual creation with individual character.

The weblog operators generally do not assume any responsibility for the postings by the readers or bloggers and a possible copyright on these postings accordingly remains on them. The weblog as such, with its contents which are potentially protected by copyright, may also, under certain circumstances, be an independently protected work since, pursuant to Article 4(1) of copyright law in Switzerland for example, collections may be independently protected if the selection or arrangement is an intellectual creation with individual character. The arrangement of the individual postings by the weblog owner and the readers' comments may contain an individual arrangement in the individual case, as can any conventional homepage as well. In this respect, if the prerequisites have been met, a weblog, as a compilation, can be protected as an independent work. The unclear situation as regards the copyright protection of individual blog articles or entire collections of articles harbours an unpredictable and unacceptable risk for potential commercial users of such articles.

In Switzerland and in other European countries, it was possible to launch free daily newspapers in tabloid format in an extremely successful manner. They are deliberately given to public transport passengers using distributors and newspaper boxes at train stations and bus stops during the morning and evening rush-hour. The advantages of conventional printed media take full effect in these printed products. There is no need for any hardware, any voltage supply and any network access. The reader can flick through the product at any desired speed and can select and read the article according to his own interest. He is not prevented from reading by a broken radio link or by a lack of bandwidth or network coverage.

Despite these important advantages of the conventional printed products over electronic media, in particular over “electronic newspapers”, the numbers of copies of conventional daily newspapers are decreasing in many European countries. Therefore, new products and production methods are of existential importance to the printed media in order to be able to exist on the news market and thus also in the highly contested competition for advertising spending by third-party companies in the face of the electronic media.

### SUMMARY OF THE INVENTION

One object of the present invention is to provide a method and a system for producing a new printed product and to provide a new printed product whilst avoiding the abovementioned disadvantages and problems.

Another object of the present invention is to optimize the costs of acquiring news and the costs of the prepress area for the new printed product.

It is likewise an object of the present invention to minimize or avoid the risk of copyright infringements when producing the new printed product.

These objects are achieved by a method for producing a printed product and a system for producing a printed product and a printed product according to independent Patent claims 1, 13 and 14.

The new printed product and the new production method and the new system exploit weblogs and the blog articles contained therein as a source of news for conventional printed media. A decisive difference from known electronic products and corresponding methods in which blog articles or postings are made available online is that, according to the present invention, the blog articles are fed into the prepress stage in a novel manner and are processed there in order to be supplied to printing forme production following layout creation which is preferably automated depending on the printing method. The methods and systems according to the invention allow the blog articles or postings to be checked, categorized and assessed in such a manner that the actual amount of editing can be considerably reduced in the prepress area. This results in massive savings since a relevant editor is advantageously provided with a preferably precategorized preselection of blog articles, ideally in the form of ranking lists, by means of assessment methods and systems, which are described in more detail below, and optionally upstream checking methods and systems. According to a preferred embodiment of the invention, the relevant editor can select the respective posting for publication from the presented preselection by simply pressing or clicking on this posting, marking a selection field associated with the posting or marking the posting in another manner, for example at a conventional desktop publishing workstation. A selected posting is preferably shown as having been selected in a visually recognizable manner, with the result that the editor can review at any time which postings have already been selected for publication.

The new method preferably uses postings by bloggers who have agreed to commercial use of their blog articles for publication in the printed product according to the invention and possible subsequent uses as part of an online registration and certification process via a blog portal. The legal certainty for the commercial operator of the blog portal and the producer of the new printed product is thus increased tremendously.

In addition, the certified bloggers are advantageously obliged to observe the guidelines and general terms and conditions of the portal operator and also to avoid contravening the basic principles of “netiquette”. Certification makes it possible to assign each article to a particular blogger and to exclude his postings from publication in the case of violations.

Each posting which is submitted at the blog portal by the certified blogger and is assigned to a desired category is allocated a posting-specific identifier which also comprises, inter alia, the selected category and an item of origin information which makes it possible to assign the posting to the author or the submitting blogger. The new postings are preferably catalogued by means of a semantic evaluation routine and are allocated to a particular blog category. If the submitting blogger has already allocated the posting to a category, automatic categorization will ideally confirm the selection or, if there is no match, will take the blogger's selection into account and will weight it appropriately during automatic categorization. A note which allows all newly incoming articles to be automatically arranged in a ranking list is preferably generated for each newly submitted blog article. It has proved to be advantageous to heavily base this note on an assessment of earlier postings by a blogger. The assessment is carried out by the readers of the printed postings and is preferably effected by SMS, email or by online access of the readers to a corresponding assessment or voting site which is integrated in the blog portal or is connected to the latter. If a printed posting by a blogger receives predominantly positive assessments by the readers, the assessment of the blogger is improved overall. The assessment of the author/blogger is taken into account when generating the note for a new article, with the result that postings by bloggers with a good assessment are further up the ranking list than those by bloggers whose previously printed postings have received mainly negative assessments. The information from the semantic analysis is preferably also used to create the ranking list, which information allows key word relevance to be determined for each article. The semantic analysis also makes it possible to calculate how well a new article fits into the corresponding predefined category. This value (also called “fit”) can likewise be taken into account when creating the ranking list for a particular category. The mathematical principles for creating such ranking lists are known to a person skilled in the art, as are the software tools for implementing them, and shall not be explained in any more detail here. The note generated for the article is preferably added to the posting-specific identifier as additional information.

Since there are inevitably not yet any assessments for postings by newly registered bloggers, they are preferably stored, with the result of the semantic analysis and the information relating to the fit for a particular category, in a separate category for first-time postings and are brought to the attention of the editor in prepress.

In preferred embodiments of the invention, the ranking list is used in the prepress stage to present a page layout to the revising editor in a fully automatic manner, which page layout is composed of the postings for each category with the best assessments and added advertisements. The editor confirms the proposal in its entirety or confirms only individual postings and replaces others. If graphical material is not provided in the postings, the editor can still insert suitable graphical material in the page layout/page creation. “Neutral” material for reader loyalty such as puzzles, Sudoku and/or comic strips can also be inserted here by the editor/person responsible for the layout.

A copy of the selected posting is preferably respectively transferred to a buffer and predefined limit values are used to check when the available space in the respective category and/or in the entire printed product has been used up. In this case, the new printed product differs quite considerably from known online newspapers which do not have such rigorous page or space restrictions.

In the simplest case, the new printed product is produced by a company, for example a newspaper publisher with a printing house. However, it is also entirely possible for a plurality of companies to be involved in production. For example, the blog portal may be operated by a first company which provides companies, for example newspaper publishers, with the certified and categorized postings which have been provided with the assessment information from the reader response. Said companies can keep the posting databases of their in-house prepress stage up-to-date and full without problems using the regularly delivered data packets.

Depending on the distribution area of the printed product to be produced, automatically, partially automatically or conventionally produced translations of blog articles are also required. This service is preferably also offered by the blog portal operator. In a particularly advantageous manner, not only are subject-specific categories offered for the blog articles in the blog portal but the blog portal appears to the outside with country-specific or region-specific subportals in the appropriate languages.

In an additional embodiment, a plurality of blog portals are operated for different geographical regions, with the result that the postings in a category, for example on the subject of politics, are recorded regionally and are supplied to editing in a subsequent step. It is thus possible to subdivide the blog articles into regions of origin for a desired category. In one preferred embodiment, the blog articles on a particular subject or in a particular category which have already been previously selected automatically or by means of editing are available, in a manner sorted according to geographical origin, for the creation of a layout. During editing, for example, the points of view on a current political subject can thus be viewed in a manner broken down into articles from North America, Europe and the Arabian region and can be compared with one another in a suitable manner in the layout with a minimum amount of effort.

The printed products which can preferably be produced by the method according to the invention and the system according to the invention include, for example, tabloid formats in DIN A4 and A5, twice-folded products and fan-folded products.

If, for example, a twelve-page tabloid is intended to be produced in A4 format according to the present invention, the relevant editor can select this format from a database containing the associated format information and format models and can define the absolute number of pages and the quantity and number of pages for the categories for publication. The amount of space available for advertisements in each category and/or overall is likewise defined in advance. As described in yet more detail below, this space for advertisements is preferably automatically filled by the system with previously categorized advertisements from an advertisement database. On the basis of these key data, the system will continuously monitor the selection operation by the editor during page layout and page creation, will preferably indicate the progress as each category is filled in a visually ascertainable manner and, when the limit set for a category is reached, will make further selection impossible or will at least transmit a warning message. In other preferred embodiments, the system automatically generates a complete proposal for the layout which can then be accepted or changed by the editor.

After the selection operation has been concluded, the editor may also be given the opportunity to subject the layout generated by the system using the selected postings and the advertisements to final inspection and to remedy errors and/or flaws in a manual processing mode.

Work such as colour correction, photomontages and all optimization work for graphical and data material also occurs in the prepress stage.

The system allocates a unique tag to all postings, but also to the advertisements, at the latest when they have been selected for publication, said tag preferably being implemented in the form of a machine-readable two-dimensional or matrix barcode in the printed state. The printed tags are arranged in the posting or in relation to the posting in such a manner that they are intuitively correctly assigned by the reader. The tag which is printed together with the posting or the advertisement is the preferred means for making it possible for the reader to interact with the new medium. The invention allows the readers to collectively influence the production of future printed products very directly and in a previously unknown manner.

Fundamental information on different types of barcodes is known and can be obtained, for example, at http://en.wikipedia.org/wiki/Bar_code and shall not be repeated again here. Depending on the size of the tag, up to 2 kilobytes of data can currently be stored and represented in printed form using two-dimensional barcodes, for example the data matrix code. Data matrix was developed by RVSI Acuity CiMatrix and now belongs to Siemens (http://www.rvsi.net). Data matrix was provided as a “public domain” by the AIM (Association for Automatic Identification and Mobility) and complies with ISO/IEC16022. Semacode is the trade name for a machine-readable barcode which comprises black and white dots and makes it possible for mobile telephones with a built-in camera to obtain Internet addresses. The Semacode specification is likewise openly accessible and is again based on the ISO/IEC 16022 data matrix standard.

Pixecode is another example of the use of a printed barcode of the data matrix type in applications, which allows the user of a smartphone or PDA with a built-in camera and Internet access to set up a connection to a particular Internet or WAP page by simply scanning/photographing the printed code.

The prior art discloses other systems which allow additional product information to be retrieved from a computer product database using product-specific barcodes with the aid of a mobile telephone with a camera. In this case, for example while shopping in the supermarket, the user photographs a product-specific barcode which is applied to the product or a display or uses the mobile camera to scan said barcode. Patent specifications U.S. Pat. No. 5,978,773 and U.S. Pat. No. 6,199,048 by NeoMedia Technologies, Inc. disclose in detail how the information which is read from the product is linked to a Uniform Resource Locator (URL) in a computer database and this URL is then returned so that the user can call up the web pages stored under the URL. U.S. Pat. No. 6,993,573 describes how a multimedia mobile telephone with Internet access can be used to automatically download product information from an information server to the mobile telephone by photographing a barcode.

Visual codes which can be read as mobile tags by mobile telephones with special software are known under the trade mark BeeTagg (http://www.beetag.ch). The mobile tags can be applied to any desired items (posters, advertisements, T-shirts, visiting cards, cars etc.). On the basis of the code contained in the mobile tag, the mobile telephone sets up a connection to the Internet with only a click after reading the tag using the built-in camera of the mobile telephone and obtains precisely the information which is relevant in the specific context of the user (for example product information or purchase decision). The technology on which this marketing-oriented system is based can advantageously be supplemented with the additional possibilities according to the present invention.

The tags which are preferably printed together with the postings and advertisements make it possible for the reader to set up a connection for the purpose of responding to the posting, of visiting a linked website, of retrieving additional information relating to an advertisement, of placing an order or of subscribing to a service by scanning said tags into a portable device, preferably a mobile telephone or a PDA (Personal Digital Assistant) with a built-in camera.

The reader response is preferably given via a voting platform of the blog portal, which platform can receive responses to particular postings, for example by SMS, email, an Internet connection or by telephone. As a result of the unique tag, each response can be automatically assigned to the correct posting and thus to the submitting blogger as early as on the voting platform. As already described above, a note is generated on the basis of the responses to the article, which note in turn affects the assessment of the author of the respective posting and the assessment of his future postings.

In one preferred embodiment of the invention, the readers are given the opportunity to comment, for example in the form of a text by SMS or an image by MMS, in a personalized or anonymous manner by reading a tag which is assigned to a particular posting. Such comments by non-certified readers are stored in a manner linked to the posting and can be taken into account during editing and can be printed in subsequent issues of the printed product.

The page layout finalized in the prepress stage is released for forme production, and, in a further section of the method which corresponds to page output and plate production according to the IFRA (International Association for Newspaper and Media Technology) terminology, at least one printing plate is produced on the basis of the forme description generated in the prepress stage or at least one file containing the data to be printed, preferably in PostScript or PDF format, is generated for a subsequent digital printing process. According to other preferred embodiments, at least one file, the so-called forme bitmap, is generated with the forme data and is used to produce printing formes by means of manual mounting, computer-to-film or computer-to-plate methods. The differences between the methods for producing electronic newspapers and the conventional prepress methods are also crucial, in particular, in imposition sheet creation. In this case, use is made of, for example, wastage programs which have to take into account parameters such as printed sheet format, gripper edges, fold and trimming but also stitching, type of binding and, if necessary, binding and format enlargement.

The plates are then used in the preferred forme-bound printing methods which are also referred to as “conventional printing methods” below. They are preferably high-capacity printing processes on printing presses, for example rotary newspaper printing, gravure or planographic printing on web-fed newspaper presses with up to 100,000 printed copies per hour.

Depending on the desired printed product, further processing is carried out following printing. In this case, folding, cutting or stitching is carried out, in particular, and/or intermediate products and/or inserts are inserted or stuck in. The finished end products are then dispatched and distributed.

On the one hand, they may be distributed using the known channels of distribution such as kiosks, paperboys or postal delivery. However, they are particularly preferably given as free newspapers which are financed by advertising, as already described above.

As already mentioned above, in preferred embodiments of the invention, the article-based contents are converted to the layout in the prepress stage in automated fashion using data which are extraneous to the article, preferably with advertisement data from advertising agencies or direct advertisers. In this case, it has proved to be particularly advantageous to avoid categorizing the advertisement data only after they have been received, which is preferably effected using a secure web-based advertisement portal, but rather to give the advertiser the choice of the category or categories in which the advertisement is to be classified.

When switching the advertisement, the advertiser defines the fundamental appearance parameters of the advertisement using a predefined selection and preferably provides the advertisement in electronic form, for example in the form of a PostScript or PDF file. He at least selects the form and size in which the advertisement is to appear and the category or categories to which it is to be assigned and when or in which period and how often it is to appear. These advertisement-related control data are stored in an advertisement database together with the actual advertisement data, that is to say the word and/or graphical information which is preferably stored in the form of a PostScript or PDF file. This is preferably a relational database, like the other databases used according to the present invention.

The control data may also comprise the information relating to whether the advertisement is to appear in black/white, in grey tones or in colour and where it is to be placed in the page template. As already described with regard to the blog articles, each printed advertisement is assigned a unique tag which allows the reader to respond to the advertisement in a known manner using a mobile telephone, a PDA, a telephone or a web browser. The response may involve, for example, ordering a product, requesting additional product information or subscribing to a service. Since the responses can be assigned to the respective advertisements, the advertiser gains valuable information regarding whether his advertisement reaches the target public and what impact his advertisement has on the latter.

The tags may also be in the form of Internet addresses or telephone numbers which can be visually ascertained by the reader, or the barcodes may be supplemented with such tags. This also allows those readers who have only a telephone or Internet access to respond to advertisements and/or postings.

### BRIEF DESCRIPTION OF THE DRAWINGS

Preferred embodiments of the methods and systems according to the invention are described below using the drawings, in which:

FIG. 1 shows a schematic overview of the production of a blog-based printed product according to a first embodiment of the invention,

FIG. 2 shows a schematic overview of the response possibilities for the readers of the new printed product according to another embodiment of the invention,

FIG. 3 shows a schematic overview of possible certification of a blogger via a blog portal, and

FIG. 4 shows a schematic illustration of the submission of postings by a certified blogger via a blog portal.

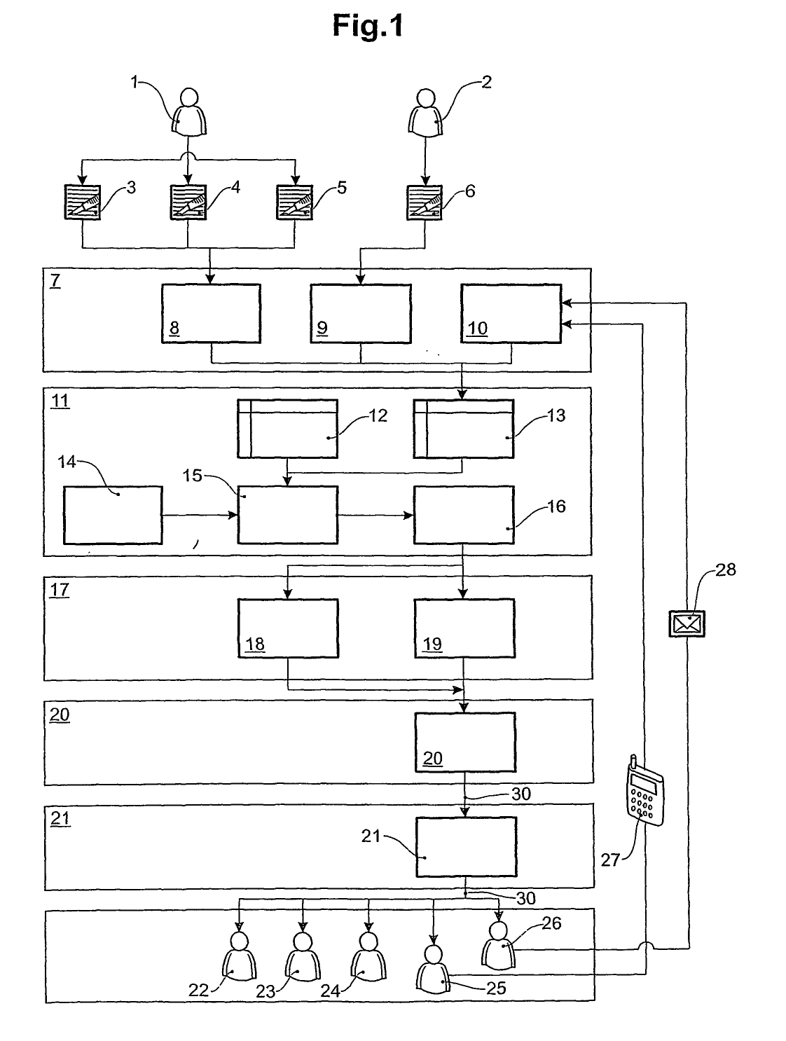

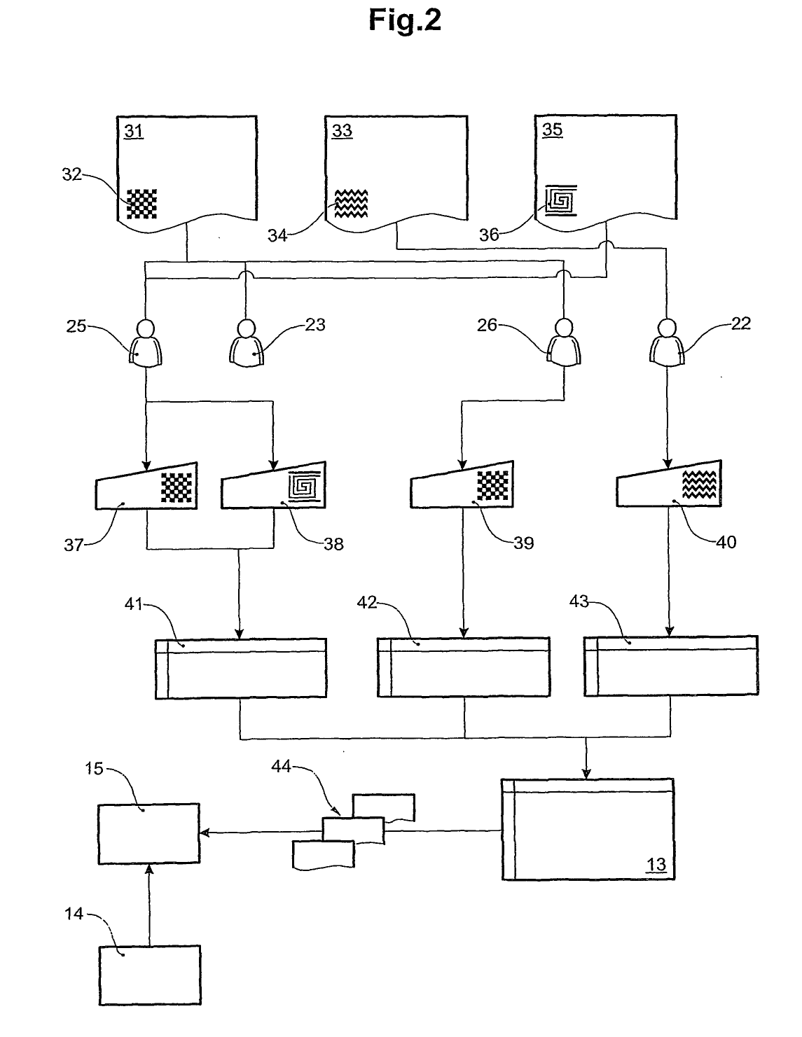

FIG. 1 illustrates how a weblogger 1 (referred to as blogger 1 for short) submits three blog articles or postings 3, 4, 5 via a blog portal 7. The three postings 3, 4, 5 are all assigned to the category A 8. A blogger 2 submits an article 6 in the category B 9. The categories in which postings can be submitted by the bloggers in the blog portal correspond to subject areas, for example politics, sports, music, cars, TV. In the exemplary embodiment illustrated, the blogger 1 submits his three postings 3, 4, 5 all in the same category A 8. On account of previous certification of the bloggers 2, 3, the postings are not anonymous but rather their text and/or graphical information is additionally associated with information relating to the submitting blogger. FIG. 1 does not illustrate that the categorization carried out by the blogger is preferably checked in the blog portal 7 or in a downstream prepress stage 11 using semantic analysis of the text articles and is corrected if necessary. Before the articles are forwarded to a posting database 13, each article by a particular blogger 1, 2 is allocated a current assessment of the blogger, who has written and/or submitted the article, by a blogger database of a voting platform 10 in the exemplary embodiment illustrated. As described in yet more detail below, the system generates a ranking list of all postings in a particular subject category in the posting database 13 which is assigned to the prepress stage in the exemplary embodiment illustrated, which list is used as a basis for the automatically generated page layout. In addition to the postings from the posting database 13, advertisements from an advertisement database 12, which are used to fully or partially finance the printed product 30, are also used during layout creation. As illustrated in different examples 32, 34, 36 in FIG. 2, each posting and preferably also each advertisement is assigned a unique posting-specific or advertisement-specific tag in the page layout 15. As already generally described above, this tag is the basis for possible interaction between the reader and the new product or the production of the latter.

The automatically created layout takes into account format information and format models which have been selected from a database and have been predefined for the layout process 15 by an editor 14, for example. The predefined absolute number of pages and the quantity and number of pages for the categories for publication are used to determine how much space is available for the postings in addition to the advertisements to be printed. Since the advertisements are preferably not intended to appear in a manner randomly distributed in the printed product, they are likewise assigned to the different categories and are automatically assigned to the pages or to the page areas of the appropriate category in the layout of the printed product by the system when creating the page layout with the postings in the same category.

By means of editing 14, the automatically generated proposal for a layout is preferably checked by an editorial coworker and corrected and/or changed if necessary. Postings and/or advertisements may be repositioned in the layout or deleted completely and replaced with other postings. On the basis of the key data such as the number and size of pages, margins etc., the system will continuously monitor the editor's processing operation during manual revision of the page layout and page creation.

The page layout finalized in the prepress stage is released for forme production 16. During page output and plate production 17, the printing formes are produced using computer-to-film methods 19 or computer-to-plate methods 18 on the basis of the forme description (forme bitmap) which is generated in the prepress stage and contains the forme data.

The plates are then used in the preferred forme-bound printing method 20. In the exemplary embodiment illustrated, they are high-capacity printing processes on printing presses, for example newspaper rotation, gravure or planographic printing on newspaper rolling machines with up to 100,000 printed copies per hour. The printed products 30 are then given to the readers 22, 23, 24, 25, 26 using the channels of dispatch and distribution 21 which have already been mentioned above.

The new printed product makes it possible for the readers to respond to the printed postings and/or advertisements using communication means, for example mobile telephones 27 or email 28.

FIG. 2 uses one preferred embodiment to explain in more detail how the readers 22, 23, 25, 26 can assess individual postings 31, 33, 35. Each printed posting 31, 33, 35 is assigned a posting-specific tag 32, 34, 36 which allows the reader to assess the article or comment on the article. In the example illustrated, reader 25 uses a mobile telephone to send responses 37, 38 to the postings 31 and 35 in the printed product to an SMS voting platform 41 via SMS. Reader 26 sends an email response 39 to posting 31 to an email voting platform 42, for example by means of a smartphone or PDA, and reader 22 uses Internet access to send a WWW response 40 to the article 33 to a WWW voting platform. Although reader 23 reads the article 31, he does not use any of the response options. The posting-specific tags 32, 34, 36 allow each response by a reader to be automatically uniquely assigned to a particular posting, for example by simply scanning the tag using the camera in his mobile telephone, and to be automatically addressed and sent to the correct recipient, in the form of voting platforms in the example illustrated.

At the recipient end, the posting-specific identification of the responses allows the responses, which are preferably stored in a database (not illustrated), to be connected to the postings. The assessment data are assigned to the blogger who wrote the posting and are stored in a blogger database which is likewise not illustrated in FIG. 2. An assessment which is stored in the blogger database is generated for each blogger on the basis of the newly incoming assessments and the already existing assessments for previously printed postings. If, for example, the printed posting 31 by a blogger receives positive assessments from the readers 25, 26, the assessment of the blogger is improved. If this blogger now submits a new article, a note is generated for this article, which note takes into account the assessment of the author/blogger among other criteria. A ranking list 44 of blogs, which are proposed for the layout 15 by the system, is generated on the basis of the notes, with the result that postings by bloggers with a good assessment are further up the ranking list than those by bloggers whose previously printed postings receive mainly negative assessments.

The machine-readable posting-specific tags 32, 34, 36 can be supplemented with additional visual information which can be read by the person reading the printed product without any aids. This freely readable information may comprise the name of the blogger or an Internet address or telephone number of an advertiser.

In order to implement the present invention on the market, an important role can be attributed to the proposed “peer review” assessment system since it is an enormous incentive for bloggers to write current, informative or else provocative articles. Whoever does not withstand the readers' assessment is no longer published in future.

A fundamental advantage of the new printed product 30 over electronic publications is that it makes it possible for the successful blogger to reach readers who cannot be reached by him using the conventional Internet platforms. It therefore not only increases the coverage for his postings but also makes them independent of devices. The possibility of their own postings being printed and distributed in a printed product with a wide circulation is already sufficient motivation for most bloggers. The method and system according to the invention also already provide all prerequisites for rewarding successful bloggers for their articles in other different forms, if this is desired.

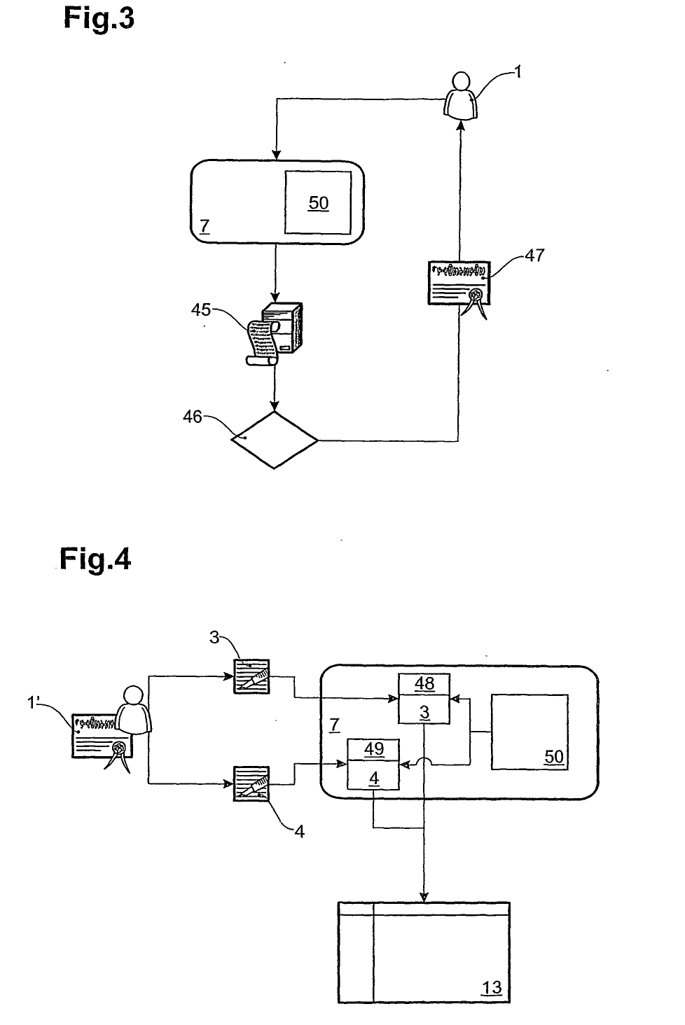

FIG. 3 illustrates how a blogger 1 registers and can be certified via the blog portal 7. In this case, he enters his personal data into a blogger database 50. The blog portal displays and/or delivers the binding guidelines 45 to the blogger and a certificate 47 is issued and transmitted to the blogger only after he has agreed 46 to the guidelines 45. The certificate 47 makes him a certified blogger 1′ and is a prerequisite for submitting certified postings 3, 4, as illustrated in FIG. 4. By agreeing to the guidelines, the blogger 1′ agrees, inter alia, to the commercial use of his postings for producing the printed product, for storage and, if necessary, for processing and other use. As a result of the certification of the bloggers, the problems, in particular copyright problems, which would arise when producing a printed product from postings which are freely available on the Internet, do not occur at all in the first place.

If the certified blogger 1′ submits new postings 3, 4 at the blog portal 7, said postings can be assigned an identifier 48, 49 using the blogger data from the blogger database. In the exemplary embodiment illustrated, the identifiers 48, 49 are posting-specific, that is to say, in addition to the identical identifier of the blogger 1′, they also already contain information relating to the posting 3, 4, or this can be subsequently added, for example during grading. The tag for each posting is then generated on the basis of the identifier. The postings 3, 4 with their identifiers 48, 49 are then transmitted to the posting database 13 where they are available for the creation of the ranking list and for the layout.

According to another embodiment of the invention, all or some of the postings by certified bloggers in the printed product are replaced with postings which are looked for on the Internet by editorial coworkers or search engines and are stored in the posting database. In order to avoid problems with copyright, quotations are given in up-to-the-minute postings in a permissible manner, the quotation preferably being stored as part of the identifier in the content of the posting or of the quoted part for subsequent printing. Postings which are not assigned the character of a work may be completely stored in the posting database, preferably again with quotation information.

### LIST OF REFERENCE NUMBERS

1, 2 Weblogger, blogger

1′ Certified blogger

3-6 Blog article, posting

7 Blog portal

8 Category A

9 Category B

10 Voting platform

11 Prepress stage

12 Advertisement database

13 Posting database

14 Editing

15 Page layout/page creation

16 Forme production

17 Page output/plate production

18 Computer-to-print

19 Computer-to-film

20 Printing

21 Dispatch/distribution

22-26 Reader

27 Mobile telephone/SMS/MMS

28 Email

29

30 Printed product

31, 33, 35 Printed postings

32, 34, 36 Posting-specific tags

37, 38 SMS responses

39 Email response

40 WWW responses

41 SMS voting platform

42 Email voting platform

43 WWW voting platform

44 Posting ranking list

45 Guideline

46 Agreement/rejection

47 Certificate

48, 49 Identifier

50 Blogger database

1. A method for producing printed product (30), wherein postings (3, 4, 5, 6) by bloggers (1, 2) are provided for a page layout (15) for a printed product (30) from a posting database (13) in a prepress stage (11).

2. The method according to claim 1, wherein at least one printing form is produced on the basis of the page layout (15) and the printed product (30) with selected postings is produced in a conventional printing process (20).

3. The method according to claim 1, wherein an identifier (48, 49) which comprises information relating to the submitting blogger (1, 2) and preferably an assessment of this blogger (1, 2) is assigned to the postings (3, 4, 5, 6) stored in the posting database (13).

4. The method according to claim 1, wherein advertisements from advertisers are provided for the page layout (15) for the printed product (30) from an advertisement database (12) in a prepress stage (11).

5. The method according to claim 1, wherein a specific tag (32, 34, 36) is respectively assigned to the postings and advertisements printed in the printed product (30).

6. The method according to claim 5, wherein the readers can provide at least one voting platform (10, 41, 42, 43) with a response (37, 38, 39, 40) which can be uniquely assigned to a posting (31, 33, 35) using the tags (32, 34, 36).

7. The method according to claim 6, wherein an assessment of the printed posting (31, 33, 35) and of the blogger of the respective posting is generated on the basis of the reader response (37, 38, 39, 40).

8. The method according to claim 7, wherein the newly submitted postings are provided for the page layout (15) from the posting database (13) in a manner compiled in a ranking list (44).

9. The method according to claim 8, wherein a note which is dependent, inter alia, on the reader assessment of the submitting blogger is generated for each posting in order to create the ranking list (44).

10. The method according to claim 5, wherein the tags are machine-readable, preferably in the form of a two-dimensional or matrix barcode, and can be scanned using cameras in mobile telephones, with the result that the reader response is identified and addressed in a posting-specific manner without further assistance from the reader, preferably with a click.

11. The method according to claim 9, wherein the bloggers receive certification (47) from the blog portal (7) after agreeing to blog guidelines (45).

12. The method according to claim 9, wherein the postings (3, 4, 5, 6) come from a plurality of blog portals, which are assigned to particular geographical regions, or from categories which are arranged according to the geographical origin of the submitting blogger.

13. A system for carrying out the method according to claim 1, wherein a blog portal (7) is connected upstream of a prepress stage (11).

14. A printed product (30) comprising:
printed postings that are provided with a posting-specific tag (32, 34, 36), the tag (32, 34, 36) preferably being at least partially machine-readable and particularly preferably being in the form of a two-dimensional or matrix barcode.

15. The printed product according to claim 14, wherein the tag stores information for uniquely identifying the associated posting and a response address.
